(19) United States
(12) Patent Application Publication
(10) Pub. No.: US 2014/0042760 A1
(43) Pub. Date: Feb. 13, 2014

(54) GRIPPING DEVICE

(71) Applicant: Hsien Huang YU, Taoyuan (TW)

(72) Inventor: Hsien Huang YU, Taoyuan (TW)

(21) Appl. No.: 13/572,744

(22) Filed: Aug. 13, 2012

(51) Int. Cl. B66C 1/42

(52) U.S. Cl. 294/111

(57) ABSTRACT

A gripping device includes a handle extended from a housing, an extension slidably attached onto the housing, a casing attached to the extension, a pair of pawls mounted in the casing and movable toward and away from each other for gripping a ticket, a trigger having a carrier pivotally attached to the handle, and a connecting device having a cable coupled to the pawls and the carrier of the trigger for allowing the pawls to be selectively moved toward each other with the carrier of the trigger and the cable. The gripping device includes fewer parts or elements to be easily and quickly manufactured and assembled with a decreased assembling procedure and with a decreased manufacturing cost.

### BACKGROUND OF THE INVENTION

1. Field of the Invention

The present invention relates to a gripping device, and more particularly to a gripping device including a simplified structure having fewer parts or elements that may be easily and quickly manufactured and assembled by the workers and that may be manufactured with a decreased assembling procedure and with a decreased manufacturing cost.

2. Description of the Prior Art

Various kinds of typical gripping, fetching, grasping, pulling, or retrieving devices have been developed and provided for conducting or operating various card or object gripping and fetching operations, and normally comprise a pair of longitudinal or straight gripping fingers rotatably secured to a base, and a handle secured to the base and coupled to the gripping fingers with various kinds of connecting or coupling members or elements for rotating or moving or actuating the gripping fingers to grasp or hold the cards, tickets, objects or the like.

For example, U.S. Pat. No. 4,483,562 to Schoolman, U.S. Pat. No. 4,962,957 to Traber, U.S. Pat. No. 6,513,844 to Hsu, U.S. Pat. No. 6,520,556 to Hsu, and U.S. Pat. No. 6,739,637 to Hsu disclose several of the typical gripping, fetching, grasping, pulling, or retrieving devices for conducting or operating various card or object gripping and fetching operations and comprising a pair of longitudinal or straight gripping fingers, a handle, and a hand grip or trigger coupled to the gripping fingers with various kinds of connecting or coupling members or elements for rotating or moving or actuating the gripping fingers to grasp or hold the cards, tickets, objects or the like.

However, the typical gripping, fetching, grasping, pulling, or retrieving devices comprise a complicated structure having a number of parts or elements that may not be easily and quickly manufactured and assembled by the workers and that may be manufactured with a greatly increased assembling procedure and with a greatly increased manufacturing cost.

The present invention has arisen to mitigate and/or obviate the afore-described disadvantages of the conventional gripping or fetching devices.

### SUMMARY OF THE INVENTION

The primary objective of the present invention is to provide a gripping device including a simplified structure having fewer parts or elements that may be easily and quickly manufactured and assembled by the workers and that may be manufactured with a decreased assembling procedure and with a decreased manufacturing cost.

In accordance with one aspect of the invention, there is provided a gripping device comprising a shell including a housing having a chamber formed therein, and a handle extended from the housing, and the handle including a compartment formed therein and communicating with the chamber of the housing, an extension slidably attached onto the housing and movable and adjustable relative to the housing, a casing attached to the extension and movable and adjustable toward and away from the housing and the handle, a fetching device including a pair of pawls pivotally mounted in the casing with a pivot shaft and movable toward and away from each other, a trigger including a carrier pivotally engaged in the compartment of the handle with a pivot axle and extendible out of the handle for being selectively actuated and depressed into the compartment of the handle, and a connecting device including a cable received in the chamber of the housing, and the cable including a first end portion for coupling to and for selectively pulling and moving the pawls toward each other, and including a second end portion coupled to the carrier of the trigger for allowing the pawls to be selectively actuated and moved toward each other with the carrier of the trigger and the cable.

The connecting device includes a sheath, and the cable is received or engaged in the sheath. The housing includes at least one anchoring device engaged with the sheath for loosely support the sheath in the chamber of the housing. The anchoring device includes at least one pin extended from the housing and engaged with the sheath.

The connecting device includes a pulling member connected to the pawls and coupled to the second end portion of the cable for selectively pulling and moving the pawls toward each other. The pawls each may further include a protrusion extended therefrom, and the pulling member two limbs coupled to the protrusions of the pawls respectively for selectively moving the pawls toward each other.

The housing includes a longitudinal channel formed therein, and a plurality of engaging members provided in the channel of the housing, and the extension includes an engaging element for selectively engaging with the engaging members of the housing and for anchoring and positioning the extension to the housing at selected positions. The engaging members are selected from depressions that are formed in the channel of the housing, and the engaging element of the extension is selected from a spring biased projection.

The housing includes a curved guide slot formed therein, and the casing includes a catch extended therefrom for slidably engaging with the guide slot of the extension and for limiting the casing to rotate relative to the extension. The casing includes a stop provided thereon for engaging with the extension and for positioning the casing to the extension.

The casing includes an opening formed therein, and a covering attached onto the casing and engaged with the stop of the casing, and includes an entrance formed therein and aligned with and communicating with the opening of the casing. The handle includes a spring biasing member coupled between the carrier and the handle for biasing and forcing the carrier to move out of the handle.

A light device may further be provided and includes a light element attached to the casing for generating a light through the entrance of the covering and the opening of the casing, and a battery electrically coupled to the light element for energizing the light element. The light device includes a switch attached to the handle and connected to the light element and the battery for controlling and switching the light element to selectively generate the light.

The trigger includes a guiding device attached to the carrier and having an endless guiding raceway formed in the guiding device, and the handle includes a spring biased detent slidably received and engaged in the endless guiding raceway of the guiding device for guiding the carrier of the trigger to move relative to the handle. The guiding device includes a latching passage and a returning pathway formed therein and mirror symmetric to each other for forming the endless guiding raceway of the guiding device and for slidably receiving and engaging with the spring biased detent.

The endless guiding raceway of the guiding device includes a starting position formed and located between the latching passage and the returning pathway of the guiding device, and a seating position formed and located between the latching passage and the returning pathway of the guiding device, a first guiding ramp provided in the latching passage of the guiding device, and a second guiding ramp provided in the returning pathway of the guiding device.

The first guiding ramp is inclined from the starting position toward the seating position of the guiding device, and includes a deeper portion located close to the starting position of the guiding device, and a shallower portion located close to the seating position of the guiding device, and the second guiding ramp is inclined from the seating position toward the starting position of the guiding device, and includes a deeper portion located close to the seating position of the guiding device, and a shallower portion located close to the starting position of the guiding device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view illustrating the operation of a gripping device in accordance with the present invention;

FIG. 2 is a partial exploded view of the gripping device;

FIG. 3 is a perspective view of the gripping device;

FIG. 4 is a side plan schematic view of the gripping device;

FIGS. 5, 6, 7 are side plan schematic views similar to FIG. 4, illustrating the operation of the gripping device;

FIG. 8 is an enlarged partial perspective view illustrating a trigger device of the gripping device;

FIG. 9 is another enlarged partial perspective view illustrating a connecting or coupling device of the gripping device;

FIG. 10 is a further enlarged partial perspective view illustrating a cam member or guiding device of the gripping device;

FIG. 11 is a still further enlarged partial perspective view of the cam member or guiding device of the gripping device; and

FIGS. 12, 13 are still further enlarged partial perspective views similar to FIG. 10, illustrating the operation of the gripping device.

### DETAILED DESCRIPTION OF THE PREFERRED EMBODIMENT

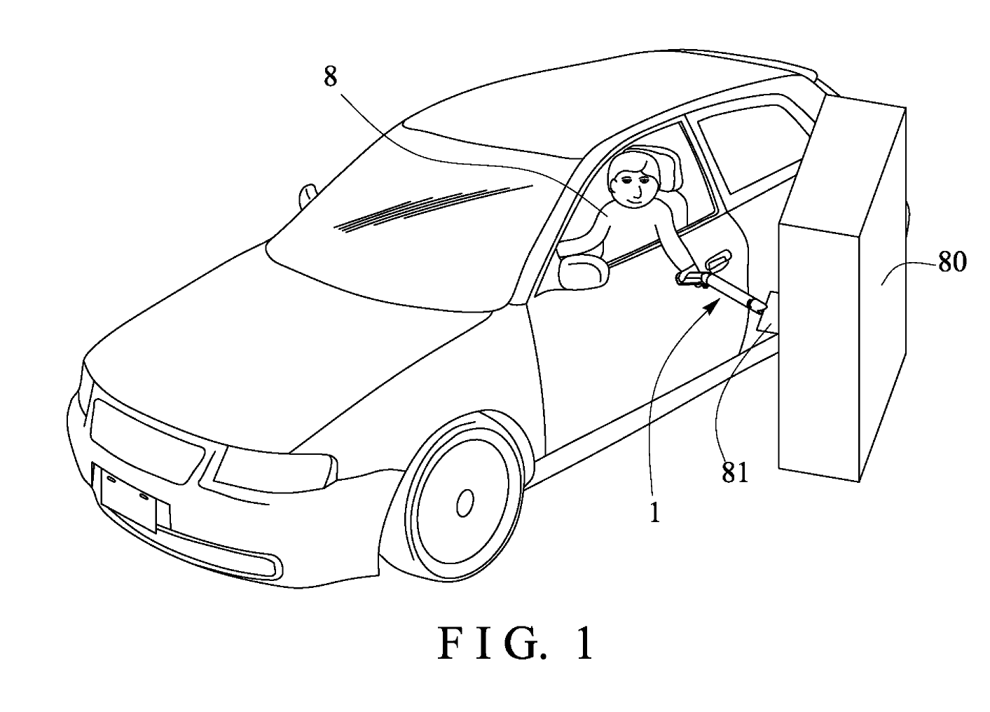

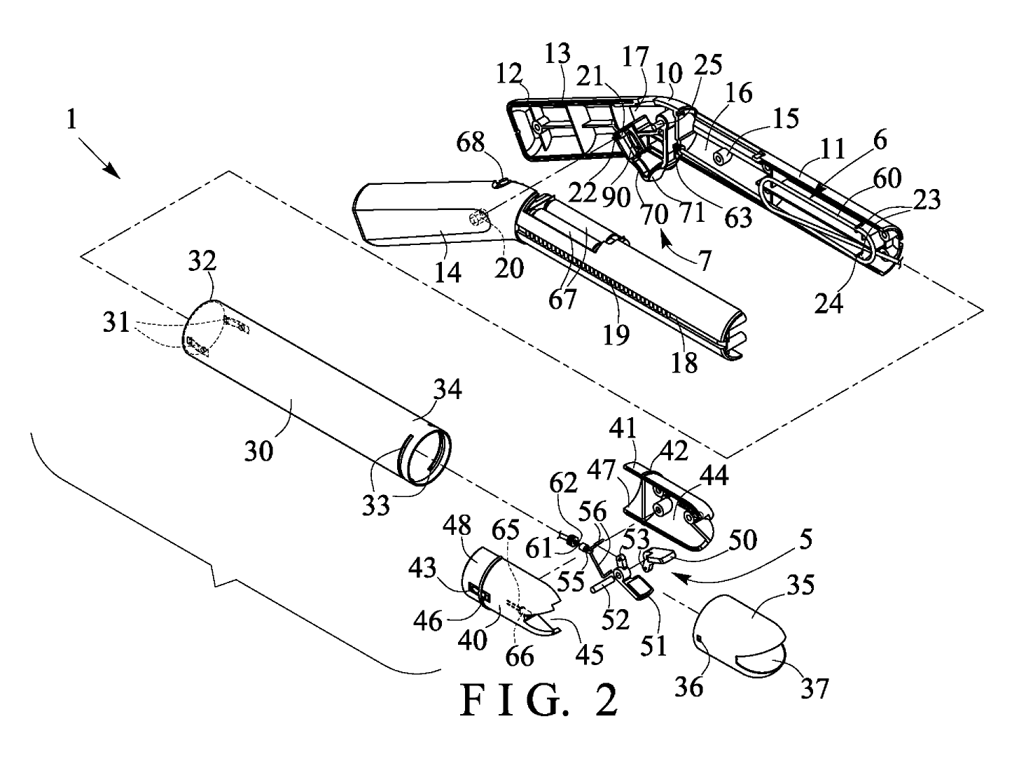

Referring to the drawings, and initially to FIG. 1, a gripping device 1 in accordance with the present invention is developed and provided for being held or carried or grasped by a user 8 who may conduct or operate various card or object gripping and fetching operations to grip or fetch a coin, a card or a ticket 81 from such as a card or ticket machine 80 or the like remotely. As best shown in FIGS. 2-5, the gripping device 1 comprises a gun body or longitudinal barrel or cylindrical or tubular body or shell 10 including a housing 11 formed or provided at the front portion thereof, and including a hand grip or handle portion or member 12 formed or provided at the rear portion thereof, and the shell 10 may include two or more receptacle or shell members 13, 14 secured together by adhesive materials, or by welding processes, and/or with fasteners or latches 15.

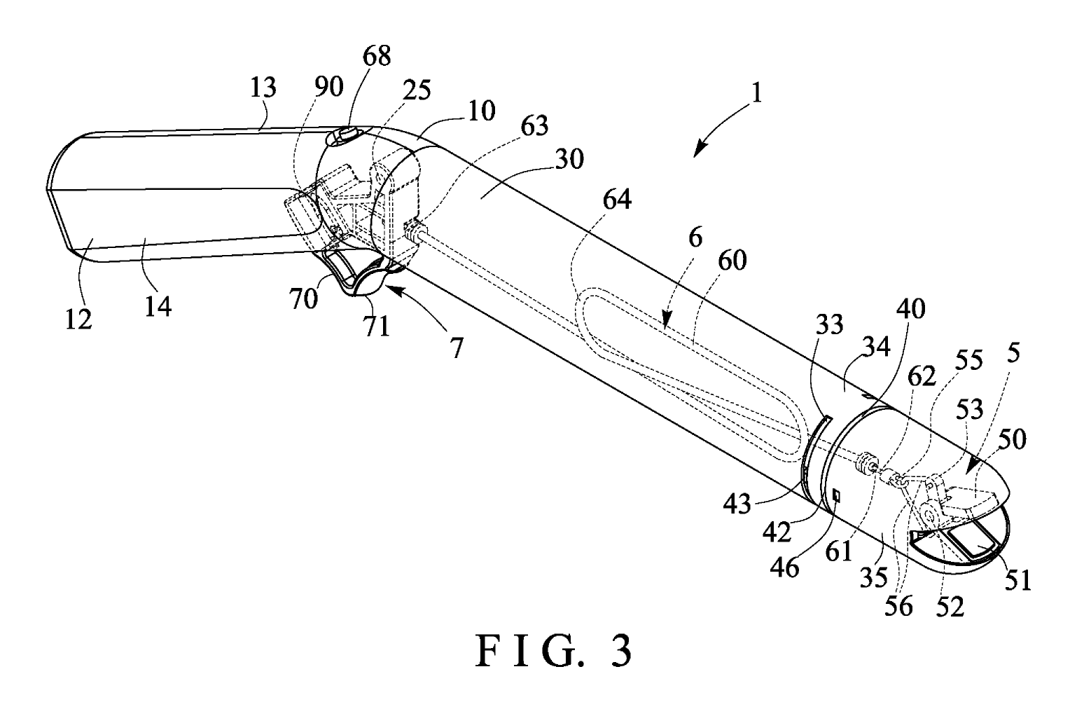

The housing 11 includes a space or chamber 16 formed therein, and the handle 12 includes a compartment 17 formed therein and communicating with the chamber 16 of the housing 11. The housing 11 further includes one or more (such as two) longitudinal grooves or channels 18 formed in the outer portion thereof, such as formed in the outer portion of the shell members 13, 14 respectively and located opposite to each other and parallel to each other, and includes a number of engaging members 19, such as teeth or protrusions or projections or recesses or depressions 19 formed or provided therein, such as formed or provided or located in the channels 18 respectively, and the handle 12 may further include a cavity 20 formed therein (FIG. 2) for slidably receiving or engaging with a pawl or detent 21 and a spring biasing member 22 therein (FIGS. 2 and 3).

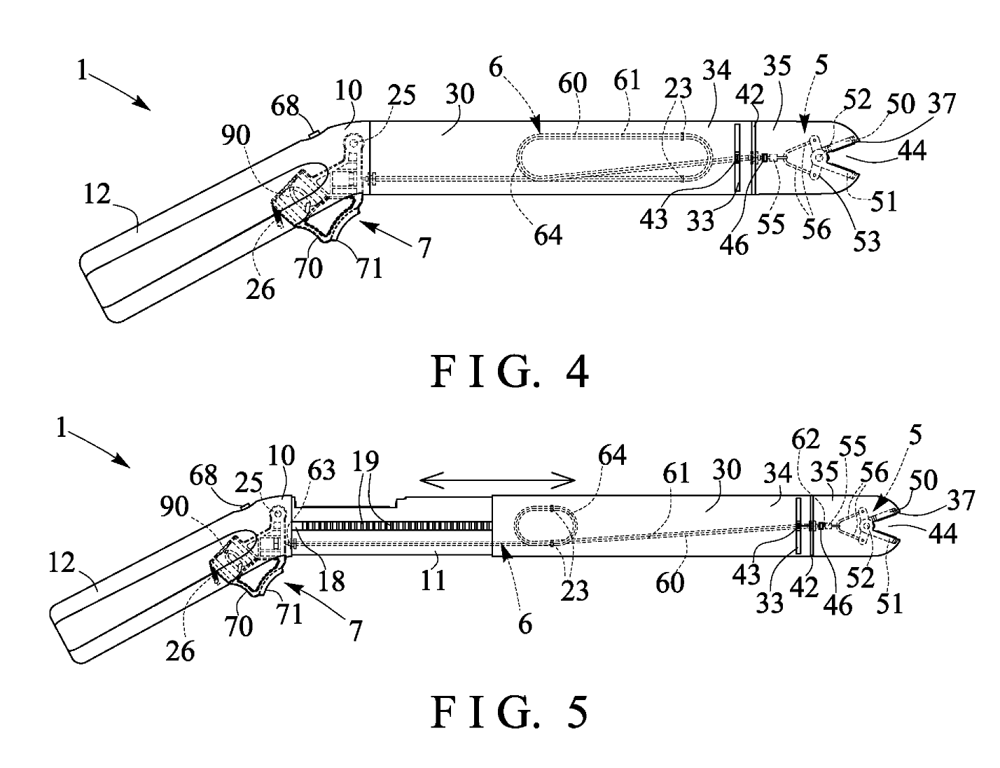

A longitudinal barrel or sleeve or tubular or cylindrical extension 30 is slidably attached or mounted or engaged onto the housing 11 and movable or slidable or adjustable or retractable relative to the housing 11 (FIGS. 4, 5), and includes one or more (such as two) engaging elements 31, such as spring biased teeth or protrusions or projections 31 extended or provided in the rear portion 32 thereof and located opposite to each other and slidably received or engaged in the channels 18 of the housing 11 respectively for selectively engaging with the engaging members or depressions 19 of the housing 11 and for anchoring or retaining or positioning the extension 30 to the housing 11 at selected or predetermined or required positions. The extension 30 further includes one or more (such as two) curved guide channels or slots 33 formed therein, such as formed or provided or located in the front portion 34 thereof and located opposite to each other.

A receptacle or hood or casing 40 includes one end or rear end portion 41 thereof slidably received or engaged into the front portion 34 of the extension 30 and movable toward or away from the housing 11 and the handle 12, and includes a ring or stop 42 formed or provided on the outer peripheral portion thereof for engaging with the extension 30 and for preventing or limiting the casing 40 to slide or move longitudinally relative to the extension 30 and for guiding the casing 40 to pivot or rotate relative to the extension 30 only, and includes one or more (such as two) latches or catches 43 extended radially and outwardly therefrom and located opposite to each other for slidably engaging with or into the guide slots 33 of the extension 30 respectively and for limiting the casing 40 to pivot or rotate relative to the extension 30 within a predetermined or required angular or rotating range, and further includes a chamber or space 44 formed therein.

The casing 40 may further include an opening 45 formed in the front portion thereof and communicating with the space 44 thereof, and further includes one or more (such as two) catches or latches 46 extended radially and outwardly therefrom and located opposite to each other. The casing 40 may also include one or more (such as two) casing members 47, 48 secured together by adhesive materials, or by welding processes, and/or with fasteners or latches (not shown). A hood or shell or receptacle or covering 35 may further be provided and attached or mounted or secured or engaged onto the casing 40, and contacted or engaged with the stop 42 of the casing 40 for anchoring or securing or retaining or positioning the covering 35 to the casing 40, and includes one or more (such as two) lock notches or orifices 36 formed therein for engaging with the latches 46 of the casing 40 and for locking or latching or anchoring or securing or retaining or positioning the covering 35 to the casing 40.

It is to be noted that the casing members 47, 48 of the casing may thus further be solidly and stably anchored or retained or secured or coupled and position together with the covering 35, and relatively, the covering 35 is solidly and stably anchored or retained or secured to the casing 40 and rotated in concert with the casing 40 relative to the extension 30. The covering 35 also includes an opening or aperture or hole or entrance 37 formed in the front portion thereof and aligned with and communicating with the opening 45 of the casing 40 and for allowing the coin, card or ticket 81 from the card or ticket machine 80 (FIG. 1) to be received or engaged through the entrance 37 of the covering 35 and then to engage into the opening 45 and the space 44 of the casing 40. It is to be noted that the entrance 37 of the covering 35 and the opening 45 of the casing 40 may be pivoted or rotated relative to the extension 30 to any selected or predetermined or required or suitable position for allowing the coin, card or ticket 81 to be easily and suitably engaged into the opening 45 and the space 44 of the casing 40.

A gripping, grasping, retrieving or fetching device 5 includes a pair of flaps or fingers or pawls 50, 51 received or engaged in the space 44 of the casing 40 and pivotally or rotatably attached or mounted or secured together and to the casing 40 with a pivot shaft 52 and located above and below the opening 45 of the casing 40 respectively, and pivotal or rotatable or movable toward or away from each other for selectively engaging with and fetching the coin, card or ticket 81 from the card or ticket machine 80, and the pawls 50, 51 each include an extension or bar or leg or protrusion 53 extended outwardly therefrom, such as extended from the other end or portion relative to the pivot shaft 52. A flexible or resilient coupling or pulling device or member 55 includes a C-shaped structure having two legs or limbs 56 connected or coupled to the protrusions 53 of the pawls 50, 51 respectively for selectively moving the pawls 50, 51 toward each other and to selectively engage with and fetch the coin, card or ticket 81.

A pulling or coupling or connecting device 6 includes a longitudinal and foldable or flexible covering or shell or sheath 60 received or engaged in the chamber 16 of the housing 11 and the extension 30 and the space 44 of the casing 40, and a longitudinal wire or cable 61 received or engaged in the sheath 60, and includes one or first end portion 62 extended out of the sheath 60 and connected or coupled to the pulling member 55 or directly connected or coupled to the pawls 50, 51 for selectively pulling and moving the pawls 50, 51 toward each other with the pulling member 55, and includes the other or second end portion 63 extended out of the sheath 60 and disposed or located in the compartment 17 of the handle 12 or of the housing 11 of the shell 10 for connecting or coupling to a trigger 7 which will be described in further details hereinafter.

A light device 65 includes one or more light members or elements 66, such as light crystal displayers, light emitting diodes 66, or the like disposed or attached or mounted or secured or engaged in the space 44 of the casing 40 (FIG. 2) and attached or mounted or secured to the casing 40 for generating a light through the entrance 37 of the covering 35 and the opening 45 of the casing 40 in order to light the coin, card or ticket 81 and the card or ticket machine 80, and for allowing the coin, card or ticket 81 to be easily seen and gripped, grasped, retrieved or fetched from the card or ticket machine 80 by the user, and one or more cells or batteries 67 are disposed or attached or mounted or secured to the housing 11 or the shell 10 and electrically connected or coupled to the light members or elements 66 for energizing the light members or elements 66, and a control button or knob or switch 68 attached or mounted or secured to the handle 12 or the housing 11 or the shell 10 and electrically connected or coupled to the light elements 66 and the batteries 67 for controlling or switching the light elements 66 to selectively generate the light.

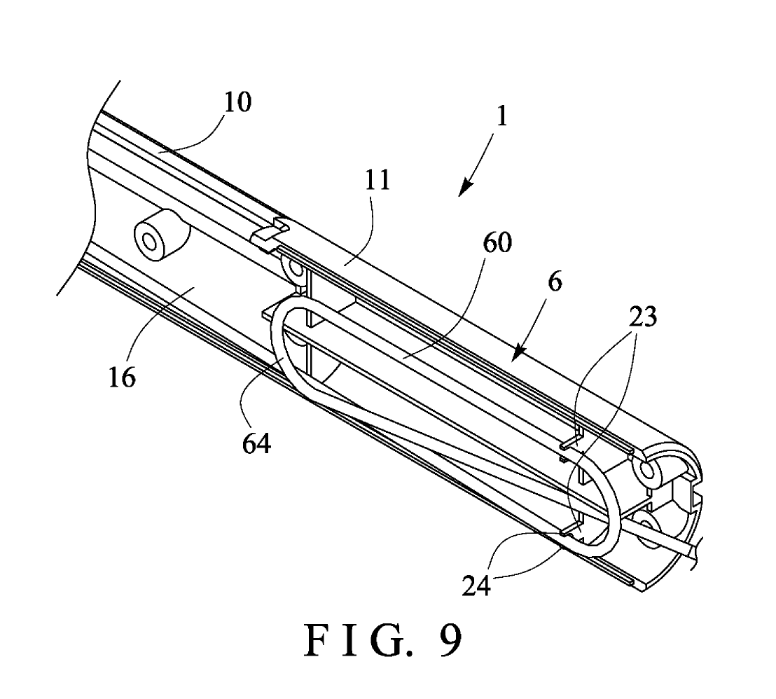

The shell 10 or the housing 11 includes one or more latching or catching or retaining or positioning or anchoring devices 23 (FIGS. 2, 9) disposed or attached or mounted or secured therein, and the anchoring devices 23 each include one or more latches or catches or pins 24 extended from the housing 11 or the shell 10 and engaged with the sheath 60 of the connecting device 6 for loosely and slidably receiving or engaging or carrying or supporting the sheath 60 within the chamber 16 of the housing 11 and the extension 30, and the sheath 60 and the cable 61 of the connecting device 6 include a foldable or flexible structure having one or more rounds or wounds or circles or coils 64 formed or provided therein for allowing the extension 30 to be suitably moved or slid or adjusted or retracted relative to the housing 11 to any selected or predetermined or required or suitable position, without being affected or interfered by the sheath 60 and the cable 61 of the connecting device 6.

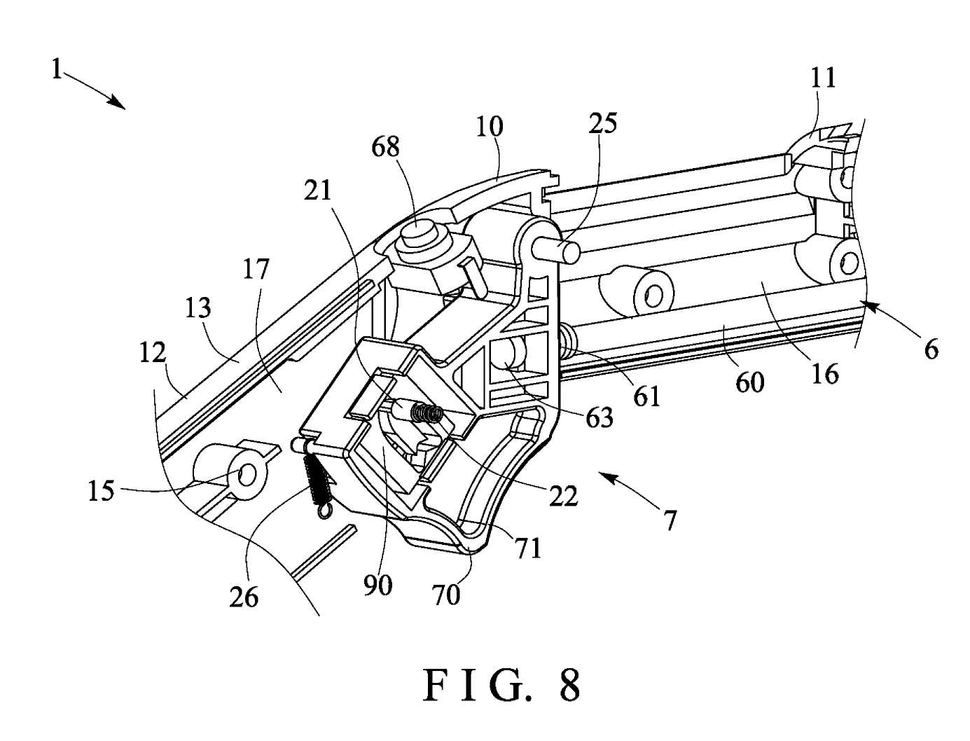

As shown in FIGS. 2 and 8, the trigger 7 includes a housing or casing or block or carrier 70 movably received or engaged in the compartment 17 of the handle 12 or of the housing 11 and pivotally or rotatably attached or mounted or secured to the handle 12 or the housing 11 with a pivot axle 25, and includes a housing or casing or button or hand grip portion or knob 71 extendible out of the handle 12 or the housing 11 for being selectively pulled or moved or depressed or compressed or actuated or operated by the user, another spring biasing member 26 is also received or engaged in the compartment 17 of the handle 12 or of the housing 11 and connected or coupled between the carrier 70 and the handle 12 or the housing 11 for biasing and forcing the knob 71 of the carrier 70 to move or extend out of the handle 12 or the housing 11. The second end portion 63 of the cable 61 is connected or coupled to the carrier 70 of the trigger 7, best shown in FIG. 8.

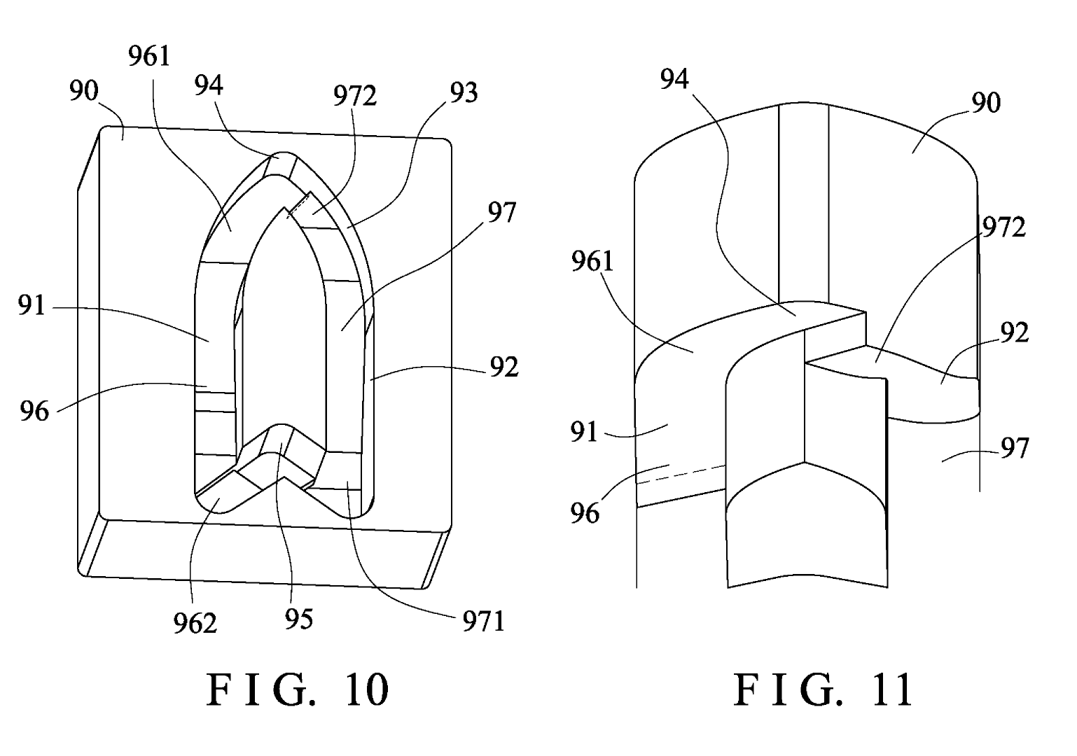

A cam member or block or guiding device 90 is received or engaged in or attached or mounted or secured to the carrier 70 of the trigger 7, as shown in FIGS. 10-13, the guiding device 90 includes a first or locking or latching passage 91 and a second or releasing or returning pathway 92 formed therein and each having a substantially J or 7-shaped structure or contour and communicating with each other and mirror symmetric to each other for forming or defining an endless guiding raceway 93 in the guiding device 90 and for slidably receiving or engaging with the spring biased detent 21 (FIGS. 2 and 8) and for guiding the carrier 70 of the trigger 7 to move relative to the handle 12 or the housing 11, and for forming or defining a middle or intermediate and upper or starting point or position 94 formed and located between the latching passage 91 and the returning pathway 92 of the guiding device 90, a middle or intermediate and lower or locking or latching or actuating or seating point or position 95 also formed and located between the latching passage 91 and the returning pathway 92 of the guiding device 90, a first guiding inclined or tilted surface or ramp 96 formed or provided in the latching passage 91 of the guiding device 90, and a second or guiding inclined or tilted surface or ramp 97 formed or provided in the returning pathway 92 of the guiding device 90.

The first guiding ramp 96 is tilted or inclined from the starting position 94 toward the seating position 95, and includes a deeper portion 961 located close to the starting position 94, and a shallower portion 962 located close to the seating position 95 for guiding the spring biased detent 21 to move from the starting position 94 and the first guiding ramp 96 toward the seating position 95, in which the seating position 95 includes a depth greater than that at the shallower portion 962 of the first guiding ramp 96 for preventing the spring biased detent 21 from being moved backward to the first guiding ramp 96. The second guiding ramp 97 is tilted or inclined from the seating position 95 toward the starting position 94, and includes a deeper portion 971 located close to the seating position 95, and a shallower portion 972 located close to the starting position 94 for guiding the spring biased detent 21 to move from the seating position 95 and the second guiding ramp 97 toward the starting position 94, in which the starting position 94 includes a depth greater than that at the shallower portion 972 of the second guiding ramp 97 for preventing the spring biased detent 21 from being moved backward to the second guiding ramp 97.

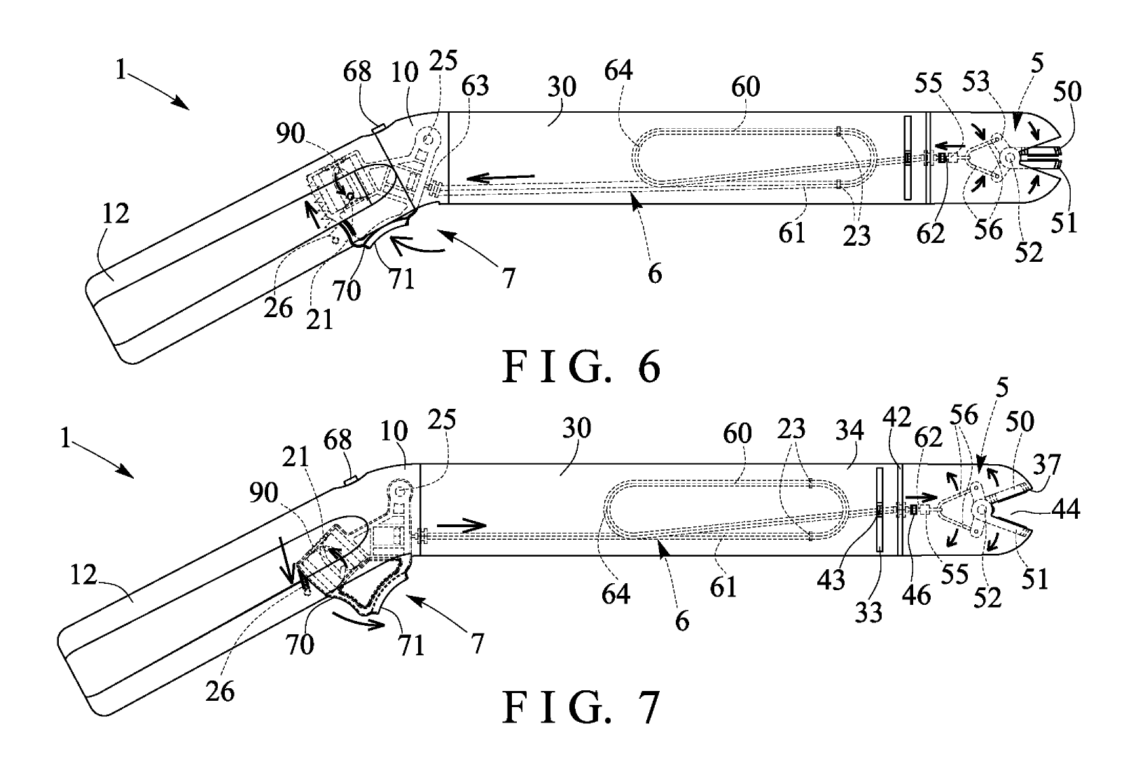

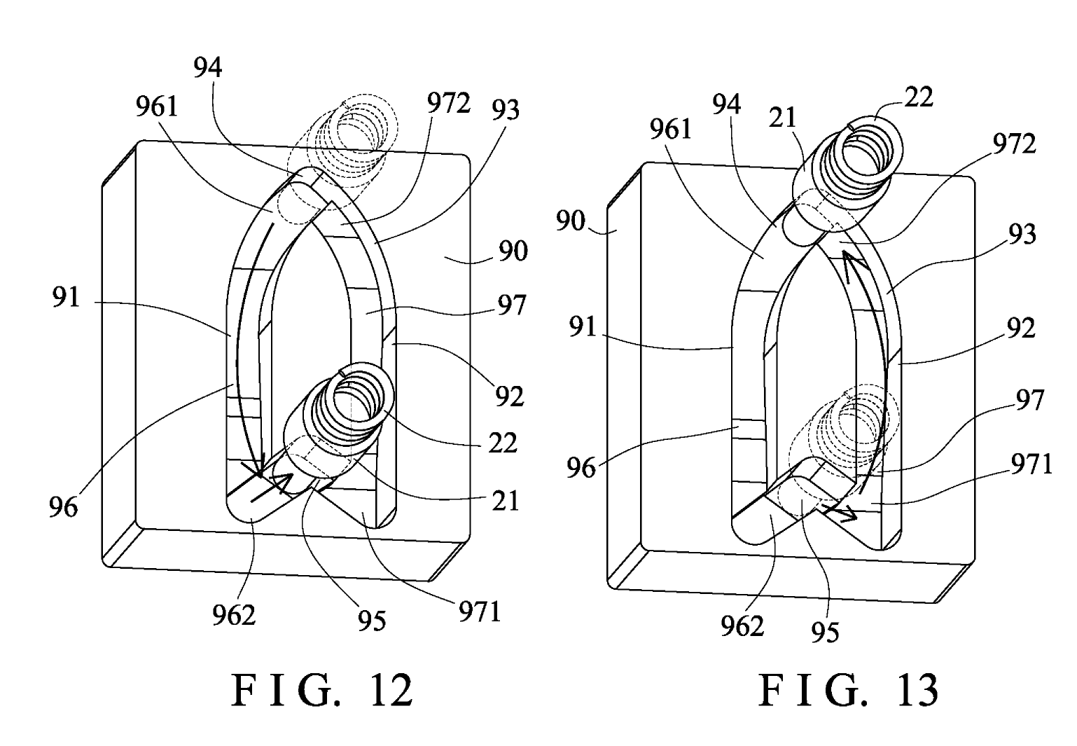

In operation, as shown in FIG. 6, when the carrier 70 of the trigger 7 is actuated or operated or depressed or compressed or pulled into the compartment 17 of the handle 12 or of the housing 11 by the user, the spring biased detent 21 may be guided to move from the starting position 94 and the first guiding ramp 96 toward the seating position 95 and to be anchored and seated and retained or positioned in the seating position 95 (FIG. 12), and the carrier 70 of the trigger 7 may then be released by the user, and the spring biasing member 26 may bias and force the carrier 70 of the trigger 7 to move or extend out of the handle 12 or the housing 11 and may also bias and force and actuate the spring biased detent 21 to have the spring biased detent 21 to be anchored and seated and retained or secured or positioned in the seating position 95 of the guiding device 90.

At this moment, or when the carrier 70 of the trigger 7 is actuated or operated or depressed or compressed or pulled into the compartment 17 of the handle 12 or of the housing 11 by the user, the pulling member 55 of the fetching device 5 may be pulled or moved toward the housing 11 and the handle 12 with the cable 61 in order to pull and move the pawls 50, 51 toward each other and to selectively engage with and fetch the coin, card or ticket 81. It is to be noted that when the coin, card or ticket 81 has been gripped, grasped, retrieved or fetched by the pawls 50, 51, the carrier 70 of the trigger 7 may be released by the user, and the spring biasing member 26 may bias and force the spring biased detent 21 to have the spring biased detent 21 to be anchored and seated and secured or retained or positioned in the seating position 95 of the guiding device 90.

As shown in FIG. 7, when it is required to release the pawls 50, 51 and the coin, card or ticket 81, the carrier 70 of the trigger 7 is actuated or operated or depressed or compressed or pulled into the compartment 17 of the handle 12 or of the housing 11 by the user again, the spring biased detent 21 may be guided to move from the seating position 95 and the second guiding ramp 97 toward the starting position 94 and to be anchored and seated and retained or positioned in the starting position 94 (FIG. 13), and the spring biasing member 26 may bias and force the carrier 70 of the trigger 7 to move or extend out of the handle 12 or the housing 11 and may also bias and force the spring biased detent 21 to have the spring biased detent 21 to be anchored and seated and retained or positioned in the starting position 94 of the guiding device 90 when the carrier 70 of the trigger 7 is released by the user.

At this moment, or when the carrier 70 of the trigger 7 is actuated or operated or depressed or compressed or pulled into the compartment 17 of the handle 12 or of the housing 11 by the user again and when the spring biased detent 21 is moved back to the starting position 94 of the guiding device 90 again, the pulling member 55 of the fetching device 5 may be released and the pawls 50, 51 may be moved away from each other to release the coin, card or ticket 81. The gripping device thus includes a simplified structure having fewer parts or elements that may be easily and quickly manufactured and assembled by the workers and that may be manufactured with a decreased assembling procedure and with a decreased manufacturing cost, and the cam member or guiding device 90 may be easily and quickly manufactured and assembled into the carrier 70 of the trigger 7.

Accordingly, the gripping device in accordance with the present invention includes a simplified structure having fewer parts or elements that may be easily and quickly manufactured and assembled by the workers and that may be manufactured with a decreased assembling procedure and with a decreased manufacturing cost.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A gripping device comprising:
a shell including a housing having a chamber formed therein, and a handle extended from said housing, and said handle including a compartment formed therein and communicating with said chamber of said housing,
an extension slidably attached onto said housing and movable and adjustable relative to said housing,
a casing attached to said extension and movable and adjustable toward and away from said housing and said handle,
a fetching device including a pair of pawls pivotally mounted in said casing with a pivot shaft and movable toward and away from each other,
a trigger including a carrier pivotally engaged in said compartment of said handle with a pivot axle and extendible out of said handle for being selectively actuated and depressed into said compartment of said handle, and
a connecting device including a cable received in said chamber of said housing, and said cable including a first end portion for coupling to and for selectively pulling and moving said pawls toward each other, and including a second end portion coupled to said carrier of said trigger for allowing said pawls to be selectively actuated and moved toward each other with said carrier of said trigger and said cable.

2. The gripping device as claimed in claim 1, wherein said connecting device includes a sheath, and said cable is received or engaged in said sheath.

3. The gripping device as claimed in claim 2, wherein said housing includes at least one anchoring device engaged with said sheath for loosely support said sheath in said chamber of said housing.

4. The gripping device as claimed in claim 3, wherein said at least one anchoring device includes at least one pin extended from said housing and engaged with said sheath.

5. The gripping device as claimed in claim 1, wherein said connecting device includes a pulling member connected to said pawls and coupled to said second end portion of said cable for selectively pulling and moving said pawls toward each other.

6. The gripping device as claimed in claim 5, wherein said pawls each include a protrusion extended therefrom, and said pulling member two limbs coupled to said protrusions of said pawls respectively for selectively moving said pawls toward each other.

7. The gripping device as claimed in claim 1, wherein said housing includes a longitudinal channel formed therein, and a plurality of engaging members provided in said channel of said housing, and said extension includes an engaging element for selectively engaging with said engaging members of said housing and for anchoring and positioning said extension to said housing at selected positions.

8. The gripping device as claimed in claim 7, wherein said engaging members are selected from depressions formed in said channel of said housing, and said engaging element of said extension is selected from a spring biased projection.

9. The gripping device as claimed in claim 1, wherein said housing includes a curved guide slot formed therein, and said casing includes a catch extended therefrom for slidably engaging with said guide slot of said extension and for limiting said casing to rotate relative to said extension.

10. The gripping device as claimed in claim 1, wherein said casing includes a stop provided thereon for engaging with said extension and for positioning said casing to said extension.

11. The gripping device as claimed in claim 1, wherein said casing includes an opening formed therein, and a covering attached onto said casing and engaged with said stop of said casing, and includes an entrance formed therein and aligned with and communicating with said opening of said casing.

12. The gripping device as claimed in claim 11, wherein a light device includes a light element attached to said casing for generating a light through said entrance of said covering and said opening of said casing, and a battery electrically coupled to said light element for energizing said light element.

13. The gripping device as claimed in claim 12, wherein said light device includes a switch attached to said handle and connected to said light element and said battery for controlling and switching said light element to selectively generate the light.

14. The gripping device as claimed in claim 1, wherein said handle includes a spring biasing member coupled between said carrier and said handle for biasing and forcing said carrier to move out of said handle.

15. The gripping device as claimed in claim 1, wherein said trigger includes a guiding device attached to said carrier and having an endless guiding raceway formed in said guiding device, and said handle includes a spring biased detent slidably received and engaged in said endless guiding raceway of said guiding device for guiding said carrier of said trigger to move relative to said handle.

16. The gripping device as claimed in claim 15, wherein said guiding device includes a latching passage and a returning pathway formed therein and mirror symmetric to each other for forming said endless guiding raceway of said guiding device and for slidably receiving and engaging with said spring biased detent.

17. The gripping device as claimed in claim 16, wherein said endless guiding raceway of said guiding device includes a starting position formed and located between said latching passage and said returning pathway of said guiding device, and a seating position formed and located between said latching passage and said returning pathway of said guiding device, a first guiding ramp provided in said latching passage of said guiding device, and a second guiding ramp provided in said returning pathway of said guiding device.

18. The gripping device as claimed in claim 17, wherein said first guiding ramp is inclined from said starting position toward said seating position of said guiding device, and includes a deeper portion located close to said starting position of said guiding device, and a shallower portion located close to said seating position of said guiding device, and said second guiding ramp is inclined from said seating position toward said starting position of said guiding device, and includes a deeper portion located close to said seating position of said guiding device, and a shallower portion located close to said starting position of said guiding device.
